(19) United States
(12) Patent Application Publication
(10) Pub. No.: US 2003/0023551 A1
(43) Pub. Date: Jan. 30, 2003

(54) Providing content over the internet to a third party

(76) Inventors: Sean Brown, Hampton (GB); Johannes Maria Victor Daanen, Bristol (GB)

Correspondence Address: HEWLETT-PACKARD COMPANY, Intellectual Property Administration, P.O. Box 272400, Fort Collins, CO, 80527-2400, US

(21) Appl. No.: 10/202,049

(22) Filed: Jul. 24, 2002

(30) Foreign Application Priority Data
Jul. 27, 2001 (GB) 0118426.6

(51) Int. Cl. G06F 17/60

(52) U.S. Cl. 705/40

(57) ABSTRACT

A method of providing content over the Internet to a third party, comprises the steps of: receiving a request for content from a purchaser, establishing payment for the requested content, and establishing an identifier to permit access to the requested content by a third party.

### FIELD OF THE INVENTION

This invention relates to a method of providing content over the Internet to a third party, a communication module for performing the method, a content provider system, a method of purchasing content, a communication module and an Internet browser provided with a module.

### DESCRIPTION OF THE PRIOR ART

A great deal of information in the form of multi-media files, hereinafter referred to as “content”, is available over the Internet. Such content may, for example, comprise images, audio or video files, HTML pages, text, or any other appropriate form of information as desired. The content may comprise streamed material, such as streamed audio or video information. The content may be output in any accessible form by using appropriate software, hereinafter referred to as a “player”.

An aim of the invention is to provide a new or improved method of providing content over the Internet.

### SUMMARY OF THE INVENTION

According to a first aspect of the invention we provide a method of providing content over the Internet to a third party, comprising the steps of:

receiving a request for content from a purchaser,

establishing payment for the requested content, and

establishing an identifier to permit access to the requested content by a third party.

The step of establishing an identifier may comprise the steps of receiving an Internet address for the third party from the purchaser.

The Internet address may comprise an Internet Protocol (IP) address.

The Internet address may comprise an e-mail address.

The step of establishing an identifier may comprise the step of generating an Internet address where the content may be accessed by the third party.

The step of establishing an identifier may comprise generating a key to permit the third party to access the requested content.

The key may comprise a password to permit the third party to access the Internet address.

The content may be encrypted and the key may comprise a key to permit the third party to decrypt the content.

The step of establishing the identifier may comprise receiving an Internet address for the third party from the purchaser and wherein the step of generating a key may include the step of encoding the Internet address into the key.

The content may only be played by a player provided with authorisation and the key may provide said authorisation.

The method may comprise the step of transmitting the identifier to the purchaser.

The method may comprise the step of transmitting the identifier to the third party.

According to a second aspect of the invention, we provide a module operable to perform a method according to the first aspect of the invention.

According to a third aspect of the present invention, we provide a content provider system, comprising content storage means and which is operable to perform a method according to the first aspect of the invention and/or is provided with a module according to the second aspect of the invention wherein the requested content is retrieved from the content storage means.

According to a fourth aspect of the present invention, we provide a method of purchasing content for provision to a third party via the Internet, comprising the steps of

transmitting a request for content to a content provider system,

establishing payment, and

establishing an identifier to permit a third party to access the requested content.

The method may comprise the step of transmitting an Internet address for the third party to the content provider system.

The step of establishing an identifier may comprise receiving an identifier from the provider system and transmitting the identifier to the third party.

The identifier may comprise an Internet address where the content may be accessed.

The identifier may comprise a key whereby the third party may access the Internet address.

The identifier may comprise a key and the key may comprise authorisation to permit a content player to play the content.

According to a fifth aspect of the present invention, we provide a communication module operable to perform a method according to the fourth aspect of the invention.

According to a sixth aspect of the present invention, we provide an Internet browser operable to perform a method according to the fourth aspect of the invention and/or where provided with a communication module according to the fifth aspect of the invention.

Hence, the present invention allows the purchaser to purchase rights to view or otherwise access playable content over the Internet and provide details of a third party to whom the content is to be supplied or who is to be able to access the content. The generation of an identifier ensures that only the authorised third party is able to access the content.

### BRIEF DESCRIPTION OF THE DRAWINGS

The invention will now be described by way of example only with reference to the accompanying drawing, wherein

FIG. 1 is diagrammatic illustration of system elements present in embodiments of the present invention; and

FIG. 2 is a flow diagram describing a first embodiment of the present invention; and

FIG. 3 is a flow diagram describing a second embodiment of the present invention.

### SPECIFIC DESCRIPTION OF PREFERRED EMBODIMENTS

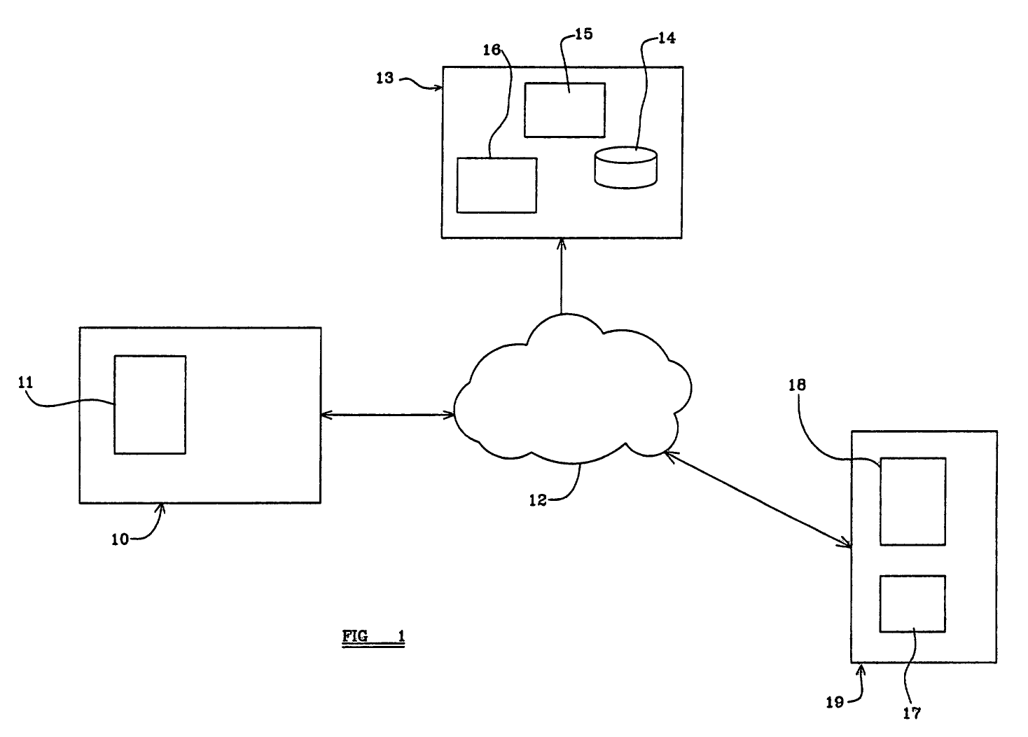

Referring now to FIG. 1, a purchaser's computer is generally illustrated at 10, for example a PC, comprising an Internet browser 11. The purchaser's computer 10 is connected to the Internet, generally indicated at 12. A content provider system is diagrammatically illustrated at 13, comprising content storage 14, a billing module 15 and an identifier generator 16. A computer system belonging to a third party is generally illustrated at 17, in the present example comprising a standard PC provided with an Internet browser 18 and a content player 19.

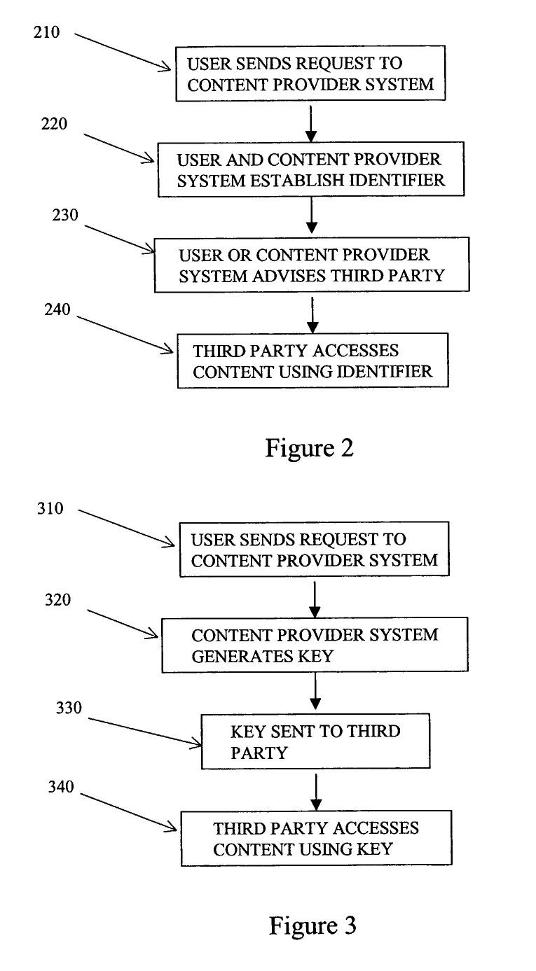

A first embodiment for purchase of content will now be described with reference to FIG. 1 and FIG. 2. To purchase content, a user sends 210 a request to the content provider system 13 to purchase the desired content, for example, by accessing the content provider system 13 via the Internet by use of the browser 11 in conventional manner. The user may select the desired content from the content storage means 14, and accept the payment terms and conditions. In this example, the content provider system 13 stores payment information in the payment information store 15 for, for example, subsequent billing to the user's credit card or any other billing or charging means as appropriate. The user and the content provider system 13 then establish 220 an identifier to permit a selected third party to access the requested content. Other options could also be offered to the user by the content supply system 13, such as the date and/or time at which the content should be supplied. The user 10 may then inform 230 the third party of the purchase, for example, via the Internet 12, or the content provider system 13 may inform the third party of the purchase as part of the service offered. To access the desired content the third party may access the content provider system 13 using hiss computer 17, and access 240 the requested content by supplying the appropriate identifier.

It will be apparent that the identifier may be established in any desired manner, bearing in mind for example the level of security required, the nature of the content being supplied and any other factors. In a simple alternative, the identifier may comprise an Internet address, for example the e-mail address of the third party, the Internet Protocol (IP) address of his computer 17, an Internet host name, or any other identifier used on the Internet or World Wide Web. The third party then supplies the identifier in response to a request from the provider 13 when attempting to access the content. When the computer 17 transmits a request to the provider system 13 for access to the requested content, the content provider system 13 can check the address of the computer 17 to ensure it is consistent with the identifier supplied. It might even be envisaged that the provider system 13 simply supplies the requested content, at the specified date and time as appropriate, to the address specified in the identifier.

It might also be envisaged that the user will specify an identifier comprising a password when making the purchase and transmits the password to the third party. When the third party then requests the content from the content provider system 13 he then supplies the password before the content is supplied.

As a further alternative, the content provider system 13 establishes an Internet address, for example an Internet URL, as the identifier, which is transmitted to the third party. The third party then accesses the address to retrieve the content.

In yet a further alternative, described with reference to FIG. 3, the content provider system 13 comprises a key generator 16. Content is requested 310 essentially as before, but now the key generator 16 generates 320 and stores a key when the purchase is made. The key 16 is then transmitted 330 to the user's computer 10 for onward transmission to the third party, or alternatively directly to the third party, for example, to his computer 17, in order to enable him to access 340 the content. The key may comprise a simple password as described above. Alternatively, it might be envisaged that the content is encrypted and the key may be used to decrypt the content to enable it to be accessed. Further or alternatively, where the third party's computer 17 is provided with a content player 19 to play the requested content, the player 19 may be operable to request the key and/or authenticate the key before playing the content, for example, by contacting the provider system 13 for confirmation, or by checking the key against authentication information attached to or embedded in the supplied content. Further information could be encoded in the key, such as the third party's address information, such as the IP address, so that the content provider system 13 and/or the player 19 can check not only that the correct key has been supplied, but also that the request for the content has come from the correct address.

It will be apparent that the content supplied by the content provider system 13 may comprise any appropriate information which may be transmitted over the Internet as desired, whether in the form of text, video or audio information, or any combination as appropriate. The purchaser may first purchase for a third party the right to view a particular piece of content, for example, streamed video coverage of a sports event, and the establishment of an identifier or other key allows the third party to view the purchased content, where appropriate at the correct time and/or date, where desirable without allowing any other party to access the content.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A method of providing content over the Internet to a third party, comprising the steps of:
receiving a request for content from a purchaser,
establishing payment for the requested content, and
establishing an identifier to permit access to the requested content by a third party.

2. A method of providing content according to claim 1 wherein the step of establishing an identifier comprises the steps of receiving an Internet address for the third party from the purchaser.

3. A method according to claim 2 wherein the address comprises an Internet Protocol (IP) address.

4. A method according to claim 3 wherein the address comprises an e-mail address.

5. A method according to claim 4 wherein step of establishing an identifier comprises generating an Internet address where the content may be accessed by the third party.

6. A method according to claim 1 wherein the step of establishing an identifier comprises generating a key to permit the third party to access the requested content.

7. A method according to claim 6 wherein the content is encrypted and the key comprises a key to permit the third party to decrypt the content.

8. A method according to claim 6 wherein the step of establishing the identifier includes receiving an Internet address of the third party from the purchaser and wherein the step of generating a key includes the step of encoding the Internet address into the key.

9. A method according to claim 6 wherein the content may only be played by a player provided with authorisation and wherein the key provides said authorisation.

10. A method according to claim 1 comprising the step of transmitting the identifier to the purchaser.

11. A method according to claim 1 comprising the step of transmitting the identifier to the third party.

12. A method of providing content over the Internet to a third party, comprising the steps of:
receiving a request for content from a purchaser,
establishing payment for the requested content, and
establishing an identifier to permit access to the requested content by a third party and generating an Internet address where the context may be accessed by the third party.

13. A method according to claim 12 wherein the step of establishing an identifier comprises generating a key to permit the third party to access the requested content.

14. A method according to claim 13 wherein the key comprises a password to permit the third party to access the Internet address.

15. A method according to claim 13 wherein the content is encrypted and the key comprises a key to permit the third party to decrypt the content.

16. A method according to claim 13 wherein the step of establishing the identifier includes receiving an Internet address of the third party from the purchaser and wherein the step of generating a key includes the step of encoding the Internet address into the key.

17. A method according to claim 13 wherein the content may only be played by a player provided with authorisation and wherein the key provides said authorisation.

18. A method according to claim 12 comprising the step of transmitting the identifier to the purchaser.

19. A method according to claim 12 comprising the step of transmitting the identifier to the third party.

20. A content provider system, comprising content storage means and a processor programmed to receive a request for content from a purchaser, to establish payment for the requested content, to establish an identifier to permit access to the requested content by a third party, and to provide the content from the content storage means when access is requested by provision of the identifier.

21. A content provider system according to claim 20 wherein the processor is adapted to generate a key, and whereby to establish an identifier the processor is adapted to generate a key to permit the third party to access the requested content.

22. A content provider system according to claim 21 wherein the content is encrypted and the key comprises a key to permit the third party to decrypt the content.

23. A content provider system according to claim 21 wherein the processor is adapted to receive an Internet address of the third party from the purchaser and to generate a key by encoding the Internet address into the key.

24 A method of purchasing content for provision to a third party via the Internet, comprising the steps of
transmitting a request for content to a content provider system,
establishing payment, and
establishing an identifier to permit the third party to access the requested content.

25. A method according to claim 24 comprising the step of transmitting an Internet address for the third party to the content provider system.

26. A method according to claim 24 wherein the step of establishing an identifier comprises receiving an identifier from the provider system and transmitting the identifier to the third party.

27. A method according to claim 26 wherein the identifier comprises an Internet address where the content may be accessed.

28. A method according to claim 27 wherein the identifier further comprises a key whereby the third party may access the Internet address.

29. A method according to claim 26 wherein the identifier comprises a key and wherein the key comprises authorisation to permit a content player to play the content.
